(19) United States
(12) Patent Application Publication
(10) Pub. No.: US 2019/0098606 A1
(43) Pub. Date: Mar. 28, 2019

(54) UPLINK SELECTION FOR WIRELESS NETWORK BASED ON NETWORK BASED ON NETWORK CELL WEIGHT AND LINKSPECIFIC WEIGHT FOR WIRELESS LINKS

(71) Applicant: NOKIA SOLUTIONS AND NETWORKS OY, Espoo (FI)

(72) Inventors: Amit Kumar Sharma, Wroclaw (PL); Samuli Turtinen, Ii (FI); Matthias Hesse, Drebach (DE); Krystian Pawlak, Wroclaw (PL)

(21) Appl. No.: 15/999,238

(22) PCT Filed: Feb. 18, 2016
(86) PCT No.: PCT/EP2016/053436

§ 371 Date: Aug. 17, 2018

(51) Int. Cl. H04W 72/02; H04W 76/15; H04B 7/0404

(52) U.S. Cl. CPC H04W 72/02; H04B 7/0404; H04W 76/15

(57) ABSTRACT

A technique may include receiving, by a user device from a base station, a cell weight for each of one or more cells; determining, by the user device, one or more link-specific factors for each of a plurality of uplink wireless links; determining, by the user device, a link-specific weight for each of a plurality of uplink wireless links based on the one or more link-specific factors for the uplink wireless link; determining, by the user device, an overall link weight for each of the plurality of uplink wireless links based on the cell weight of a cell for the uplink wireless link and the determined link-specific weight for the uplink wireless link; and selecting, by the user device based on the overall link weight for each of the plurality of uplink wireless links, one or more uplink wireless links for transmitting data.

### TECHNICAL FIELD

This description relates to communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments.

A global bandwidth shortage facing wireless carriers has motivated the consideration of the underutilized millimeter wave (mmWave) frequency spectrum for future broadband cellular communication networks, for example. mmWave (or extremely high frequency) may, for example, include the frequency range between 30 and 300 gigahertz (GHz). Radio waves in this band may, for example, have wavelengths from ten to one millimeters, giving it the name millimeter band or millimeter wave. The amount of wireless data will likely significantly increase in the coming years. Various techniques have been used in attempt to address this challenge including obtaining more spectrum, having smaller cell sizes, and using improved technologies enabling more bits/s/Hz. One element that may be used to obtain more spectrum is to move to higher frequencies, above 6 GHz. For fifth generation wireless systems (5G), an access architecture for deployment of cellular radio equipment employing mmWave radio spectrum has been proposed. Other example spectrums may also be used, such as cmWave radio spectrum (3-30 GHz).

Dual connectivity allows a user device to typically receive downlink communication from two different base stations or cells.

### SUMMARY

According to an example implementation, a method may include receiving, by a user device from a base station, a cell weight for each of one or more cells, determining, by the user device, one or more link-specific factors for each of a plurality of uplink wireless links, determining, by the user device, a link-specific weight for each of a plurality of uplink wireless links based on the one or more link-specific factors for the uplink wireless link, determining, by the user device, an overall link weight for each of the plurality of uplink wireless links based on the cell weight of a cell for the uplink wireless link and the determined link-specific weight for the uplink wireless link, and selecting, by the user device based on the overall link weight for each of the plurality of uplink wireless links, one or more uplink wireless links for transmitting data.

According to another example implementation, an apparatus may include at least one processor and at least one memory including computer instructions, when executed by the at least one processor, cause the apparatus to receive, by a user device from a base station, a cell weight for each of one or more cells, determine, by the user device, one or more link-specific factors for each of a plurality of uplink wireless links, determine, by the user device, a link-specific weight for each of a plurality of uplink wireless links based on the one or more link-specific factors for the uplink wireless link, determine, by the user device, an overall link weight for each of the plurality of uplink wireless links based on the cell weight of a cell for the uplink wireless link and the determined link-specific weight for the uplink wireless link, and select, by the user device based on the overall link weight for each of the plurality of uplink wireless links, one or more uplink wireless links for transmitting data.

According to another example implementation, a computer program product may include a computer-readable storage medium and storing executable code that, when executed by at least one data processing apparatus, is configured to cause the at least one data processing apparatus to receiving, by a user device from a base station, a cell weight for each of one or more cells, determining, by the user device, one or more link-specific factors for each of a plurality of uplink wireless links, determining, by the user device, a link-specific weight for each of a plurality of uplink wireless links based on the one or more link-specific factors for the uplink wireless link, determining, by the user device, an overall link weight for each of the plurality of uplink wireless links based on the cell weight of a cell for the uplink wireless link and the determined link-specific weight for the uplink wireless link, and selecting, by the user device based on the overall link weight for each of the plurality of uplink wireless links, one or more uplink wireless links for transmitting data.

According to another example implementation, an apparatus may include means for receiving, by a user device from a base station, a cell weight for each of one or more cells, means for determining, by the user device, one or more link-specific factors for each of a plurality of uplink wireless links, means for determining, by the user device, a link-specific weight for each of a plurality of uplink wireless links based on the one or more link-specific factors for the uplink wireless link, means for determining, by the user device, an overall link weight for each of the plurality of uplink wireless links based on the cell weight of a cell for the uplink wireless link and the determined link-specific weight for the uplink wireless link, and means for selecting, by the user device based on the overall link weight for each of the plurality of uplink wireless links, one or more uplink wireless links for transmitting data.

According to an example implementation, a method may include determining a cell weight based on one or more cell-specific factors, wherein the cell weight may be used by one or more user devices to select one or more uplink wireless links for performing uplink communication, determining a buffer threshold that triggers one or more user devices to perform uplink transmission via a plurality of uplink wireless links based on uplink multi-connectivity when an amount of data in the uplink buffer of the user device is greater than the threshold, transmitting the cell weight to one or more user devices, transmitting the buffer threshold to one or more user devices, and receiving data transmitted from one or more of the user devices.

According to another example implementation, an apparatus may include at least one processor and at least one memory including computer instructions, when executed by the at least one processor, cause the apparatus to determine a cell weight based on one or more cell-specific factors, wherein the cell weight may be used by one or more user devices to select one or more uplink wireless links for performing uplink communication, determine a buffer threshold that triggers one or more user devices to perform uplink transmission via a plurality of uplink wireless links based on uplink multi-connectivity when an amount of data in the uplink buffer of the user device is greater than the threshold, transmit the cell weight to one or more user devices, transmit the buffer threshold to one or more user devices, and receive data transmitted from one or more of the user devices.

According to another example implementation, a computer program product may include a computer-readable storage medium and storing executable code that, when executed by at least one data processing apparatus, is configured to cause the at least one data processing apparatus to perform a method including determining a cell weight based on one or more cell-specific factors, wherein the cell weight may be used by one or more user devices to select one or more uplink wireless links for performing uplink communication, determining a buffer threshold that triggers one or more user devices to perform uplink transmission via a plurality of uplink wireless links based on uplink multi-connectivity when an amount of data in the uplink buffer of the user device is greater than the threshold, transmitting the cell weight to one or more user devices, transmitting the buffer threshold to one or more user devices, and receiving data transmitted from one or more of the user devices.

According to another example implementation, an apparatus may include means for determining a cell weight based on one or more cell-specific factors, wherein the cell weight may be used by one or more user devices to select one or more uplink wireless links for performing uplink communication, means for determining a buffer threshold that triggers one or more user devices to perform uplink transmission via a plurality of uplink wireless links based on uplink multi-connectivity when an amount of data in the uplink buffer of the user device is greater than the threshold, means for transmitting the cell weight to one or more user devices, means for transmitting the buffer threshold to one or more user devices, and means for receiving data transmitted from one or more of the user devices.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example implementation.

FIG. 2 is a block diagram illustrating a protocol stack for a user device according to an example implementation.

FIG. 3 is a flow chart illustrating operation of a user device according to an example implementation.

FIG. 4 is a diagram illustrating operation of a network device or base station according to an example implementation.

FIG. 5 is a flow chart illustrating operation of a network device or base station according to another example implementation.

FIG. 6 is a flow chart illustrating operation of a user device according to another example implementation.

FIG. 7 is a block diagram of a wireless station (e.g., base station/access point or mobile station/user device) according to an example implementation.

### DETAILED DESCRIPTION

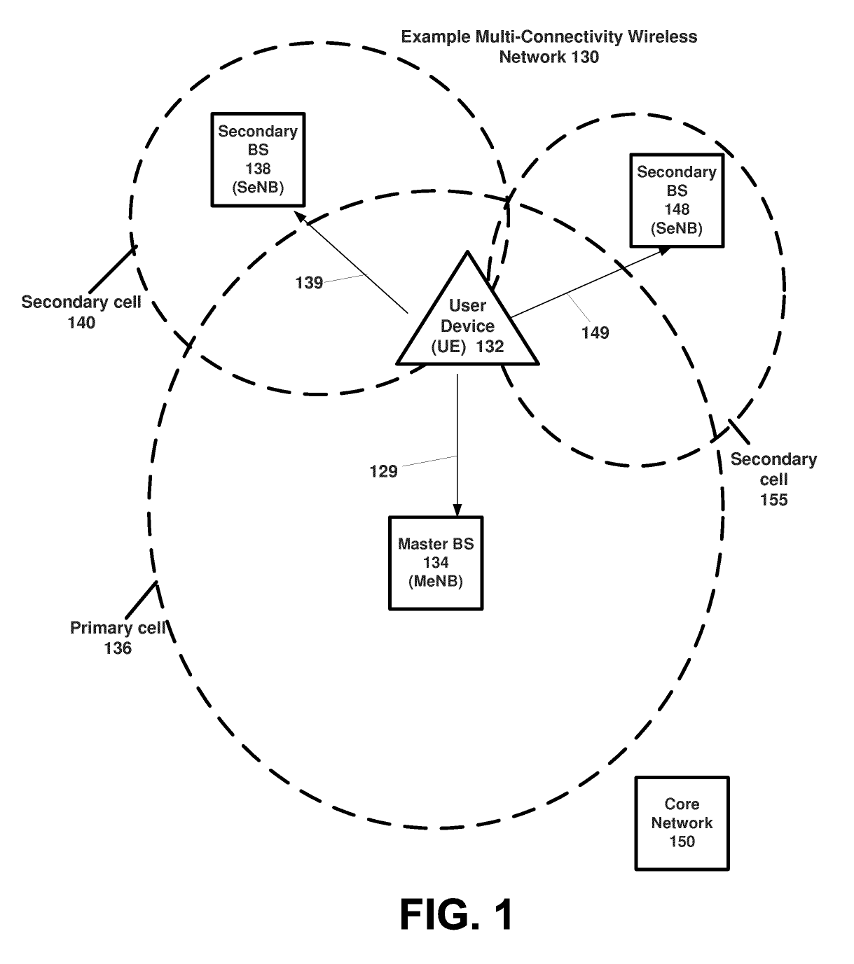

FIG. 1 is a block diagram of a wireless network 130 according to an example implementation. In the wireless network 130 of FIG. 1, a user device 132, which may also be referred to as a mobile station (MS) or user equipment (UE), may be connected to (and in communication with) a base station (BS, which may also be referred to an access point (AP) or an enhanced Node B (eNB). In an example implementation, the user device 132 may be connected to and in communication with a plurality of BSs, such as a master BS 134, and one or more of secondary BSs, such as with BS 138 and secondary BS 148, e.g., as part of multi-connectivity. According to an example implementation, master BS (MeNB) 134 may provide wireless communications/services to user devices within or near primary cell 136; secondary BS (SeNB) 138 may provide wireless communications/services to user devices within or near secondary cell 140; and, secondary BS (SeNB) 148 may provide wireless communications/services to user devices within or near secondary cell 150. In multi-connectivity, the user device 132 may be simultaneously connected to multiple cells/BSs (e.g., two or more cells/BSs).

For example, multi-connectivity may significantly improve per-user throughput and mobility robustness by allowing users/user devices to be connected simultaneously to a master cell group (MCG) and one or more secondary cell groups (SCGs) via a Master BS/MeNB (master eNB) and one or more Secondary BSs/SeNBs (secondary eNBs), respectively. The increase in per-user throughput may be achieved, for example, by aggregating radio resources to/from at least two BSs/eNBs. Moreover, in some cases, multi-connectivity may also assist in load balancing between MCG and SCG (between a master cell and one or more secondary cells). For example, with multi-connectivity, data throughput to/from a user device may be increased by splitting traffic, in some ratio, among multiple radio/wireless paths (or among multiple cells or BSs), or reliability may be increased by duplicating the transmission of data to/from a user device by among multiple radio/wireless paths (or among multiple cells or BSs).

At least part of the functionalities of an access point (AP), base station (BS) or (e)Node B (eNB) may be also be carried out by any node, server or host which may be operably coupled to a transceiver, such as a remote radio head. Each of the BSs (BSs 134, 138, 148) may be connected to a core network 150, as shown in FIG. 1. This is merely one example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

The various example implementations may be applied to a wide variety of wireless technologies or wireless networks, such as LTE, LTE-A, 5G, cmWave, and/or mmWave band networks, or any other wireless network. LTE, 5G, cmWave and mmWave band networks are provided only as illustrative examples, and the various example implementations may be applied to any wireless technology/wireless network.

Therefore, according to one example implementation, a multi-connectivity wireless network allows for a user device (such as user device 132) to be simultaneously connected to multiple base stations, e.g., simultaneously connected to both a master BS (or MeNB) 134, and to one or more of a secondary BSs (SeNBs), such as BS 138 and/or BS 148. A multi-connectivity wireless network, such as the network 130 shown in FIG. 1 may have several advantages, such as, for example, allowing decreasing a signaling load to/from the core network, sharing traffic/packet processing among multiple base stations, as well as benefiting from flexible resource usage where one or more carriers may be used on a radio link between the MS and each BS, e.g., inter-site carrier aggregation, increased throughput based on splitting of traffic via multiple wireless links/radio legs or alternatively increased reliability via duplication of traffic on multiple wireless links/radio legs, for example.

According to an example implementation of multi-connectivity, there is not necessarily a master BS and one or more secondary/slave BSs, but rather, only multiple BSs/cells to which the user device may be connected. Thus, in an example implementation of 5G (for example) multi-connectivity, the user device may be connected to a set (or active set) of BSs/cells.

According to an example implementation, user device 132 may select one or more uplink wireless links, out of a plurality of uplink wireless links, for transmitting uplink data or signals (traffic) to core network 150. A wireless connection between user device 132 and a BS may include a bi-directional wireless link(s) (e.g., including both uplink and downlink wireless links) and/or one or more uni-directional (e.g., uplink and/or downlink) wireless links. Each of the different uplink wireless links may allow user device 132 to transmit uplink data or signals to a different cell or BS, for example. Example uplink wireless links may include, for example, an uplink wireless link 129 from user device 132 to master BS 134, an uplink wireless link 139 from user device 132 to secondary BS 138, and an uplink wireless link 140 from user device 132 to secondary BS 148. Although only three illustrative uplink wireless links (e.g., 129, 139 and 149) are shown, any number of uplink wireless links may be provided and/or available for use by a user device.

Although not shown, each base station (BS) and the user device (or UE) 132 includes a processor, memory and one or more wireless transceivers (wireless transmitter/receiver). Master BS 134 (or MeNB), and one or more of secondary BS 138 (or SeNB) and secondary BS 148 (SeNB) may be connected via a bidirectional backhaul connection (which may be wired or wireless). One or more (or all) of BSs 134, 138, 148 may be connected to the core network 150 via a bidirectional S1 interface. A user device 132 may, for example, be simultaneously connected to one or more BSs, such as being connected to master BS 134 via a radio/wireless link 129, to secondary BS 138 via a radio/wireless link 139, and to secondary BS 148 via a radio/wireless link 149, for example.

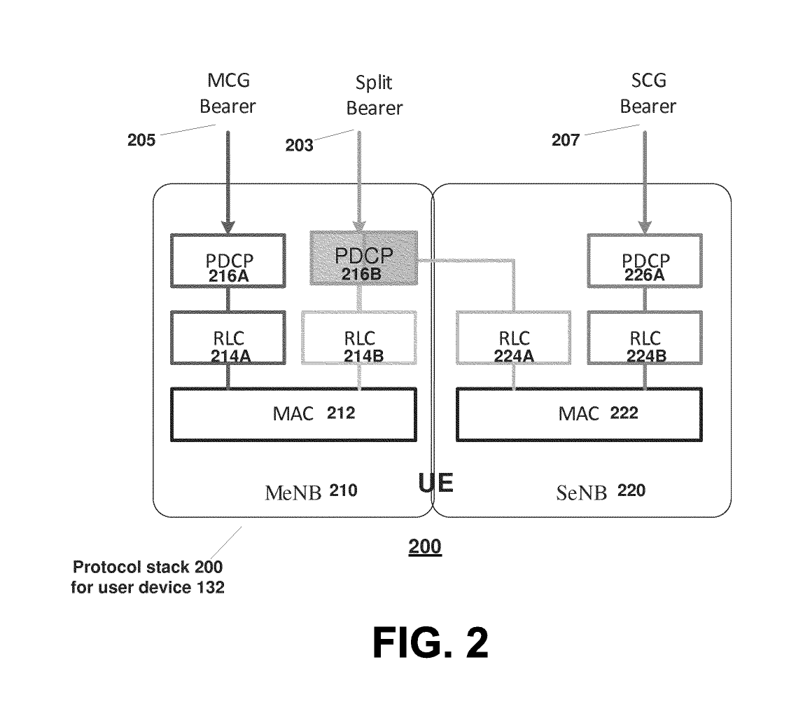

FIG. 2 is a block diagram illustrating a protocol stack that allows multi-connectivity for a user device according to an example implementation. User device 132, BS 134, BS 138 and BS 148 may each include at least one radio protocol stack that may be implemented in hardware and/or software. According to an example implementation, a protocol stack may include logic, and/or computer instructions executed by a processor to perform the functions or operations for each entity of the protocol stack. The protocol stack is illustrated (e.g., in FIG. 2) and described for user device 132. However, each BS may include a similar protocol stack. An example protocol stack 200 for user device 132 is shown in FIG. 2 for communicating with multiple BSs. For example, protocol stack 200 may include a protocol stack 210 for communicating with master BS 134/MeNB, and a protocol stack 220 for communicating with secondary BS 138/SeNB. User device 132 may include an additional protocol stack (not shown) that is the same as or similar to protocol stack 220 for communicating with secondary BS 148/SeNB. Protocol stacks 210 and 220 may each include, for example, at least a Packet Data Convergence Protocol (PDCP) entity, a Radio Link Control (RLC) entity, a Media Access Control (MAC) entity, a Physical layer (PHY) entity, and a Radio Resource Control (RRC) entity. Although not shown, MAC entity 212 and MAC entity 222 may be connected to either separate physical layer (PHY) entities or a common PHY entity that may perform physical layer functions such as transmitting and receiving signals over one or more antennas.

As shown in FIG. 2, protocol stack 210 is provided as part of user device 132 to allow user device 132 to process information and/or to communicate with (transmit to and/or receive from) master BS/MeNB 134, while protocol stack 220 is provided as part of user device 132 to allow user device 132 to process information and/or to communicate with (transmit to and/or receive from) secondary BS/SeNB 138.

A protocol stack may be provided for one or more bearers. Several different bearer types may be used. A first type of bearer is a master cell group (MCG) bearer, such as MCG bearer 205, in which uplink data or traffic (from the UE) for the MCG bearer 205 is processed and transmitted from user device 132 via PDCP entity 216A, RLC entity 214A, MAC entity 212 and wireless link 129 to a MCG including master BS (MeNB) 134. A MCG may include one or more cells controlled by the master BS. A second type of a bearer is a secondary cell group (SCG) bearer, such as, for example, SCG bearer 207, in which uplink data or traffic are processed and forwarded from user device 132 via PDCP entity 226A, RLC entity 224B and MAC entity 222 and via wireless link 139 to the one or more cells of the SCG, such as to secondary BS (or SeNB) 138. A third type of bearer may be a split bearer, such as split bearer 203, in which data for the split bearer may be split or divided (split among multiple wireless links/cells, e.g., to increase throughput) or duplicated (duplicated among multiple wireless links/cells, e.g., to increase reliability) by PDCP entity 216B and then forwarded via RLC entity 214B, MAC 212 and wireless link 129 to master BS 134, and/or forwarded via RLC entity 224A, MAC 222 and wireless link 139 to a secondary BS 138.

A PDCP entity may perform ciphering (encryption and decryption of data) and header compression-decompression. Also, a PDCP entity may also split or duplicate traffic in the uplink direction, and may be combine traffic received from multiple wireless links/cells in the downlink direction (traffic received from one or more BSs). A RLC entity may perform segmentation/concatenation, error detection and correction, data retransmission, duplicate detection and in-sequence data delivery to higher layers. According to an example implementation, there may be one RLC entity per radio bearer or multiple RLC entities per radio bearer configured for a user device. A MAC entity performs multiplexing of logical channels (where there may be one or more logical channel per radio bearer), hybrid ARQ (automatic repeat request) retransmissions, inserting of MAC control elements (MAC CEs) used for in-band control signaling, and other MAC-related functions. The UE MAC entity may also perform uplink scheduling. The MAC entity provides services to the RLC entities in the form of logical channels. A PHY entity handles or performs coding/decoding, modulation/demodulation, multi-antenna mapping, and other physical layer functions. Multiple RLC entities within a user device may, for example, share one MAC entity and one PHY entity. For example, RLC entities 214A and 214B share MAC entity 212. Although not shown, each BS may include peer protocol entities including a PDCP entity, RLC entity, a MAC entity, and a PHY entity, among other protocol entities.

In an example implementation, PDCP entity 216B of UE 132 may receive uplink traffic for split bearer 203, and then may either split or duplicate the received traffic onto two or more wireless links/cells to provide multiple paths for uplink traffic. Thus, PDCP entity 216B may be configured to operate in a split mode to split uplink traffic among multiple uplink wireless links or cells according to a specific ratio, or may be configured to operate in a duplicate mode to duplicate received traffic onto each of the multiple uplink wireless links/cells. For example, PDCP entity 216B may split traffic according to a specific (and variable) ratio, e.g., 50% of traffic provided to each of two uplink wireless links/cells; ⅓ of traffic provided to each of three uplink wireless links/cells; or to split uplink traffic according to an uneven ratio where more traffic may be sent over a higher quality or higher ranked wireless link(s)/cell(s), and less (or lower percentage) of the traffic may be sent over lower quality or lower ranked uplink wireless links/cells, such as, for example, 60% of traffic sent over a first uplink wireless link/cell, 30% of the traffic sent over a second uplink wireless link/cell, and 10% of the uplink traffic sent over a third uplink wireless link/cell. These are merely a few illustrative examples, and other numbers or examples may be used.

Although not shown, the user device and each BS may include a radio resource control (RRC) entity for handling a number of functions or procedures related to the Radio Access Network (RAN), including broadcast of system information necessary for the user device to be able to communicate with a cell or BS, transmission of paging messages originating from the core network 150 to notify a user device about incoming connection requests, connection management including setting up bearers and mobility, mobility functions such as change of servings cells and handover, and other control related functions. According to an illustrative example implementation, the RRC entity may be provided in a master BS and a user device, but may not necessarily be provided (or operating) in a secondary BS (SeNB), for example.

According to an example implementation, a user device may select one or more uplink wireless links for transmitting data. The selection of one or more uplink wireless links may be based on both: 1) cell-specific information for one or more cells that may describe conditions at the cell, and 2) link-specific information that may describe conditions for each wireless link. By considering both local link-specific information and more global (or larger scale) cell-specific information in its decision making, the user device may better select a best or optimum uplink wireless link, or a best set of uplink wireless links, for transmitting uplink data or signals. The user device may, for example, rank each of a plurality of uplink wireless links based on both the cell-specific information for one or more cells and the link-specific information for one or more uplink wireless links, and then may select the one or more highest ranked uplink wireless links for uplink communication.

According to an example implementation, cell-specific information may include a cell weight for one or more cells, where a cell weight may, for example, indicate a cell's state (or status), such as providing an overall load status of the cell or indicating the cell's availability (or unavailability) to handle new traffic. User device 132 may receive a cell weight from each of multiple cells. For example, user device 132 may receive a cell weight from each of: master BS 134 for cell 136, secondary BS 138 for cell 140, and secondary BS 148 for cell 155, for example. In an illustrative example implementation, each cell weight may reflect, indicate, describe or be based upon one or more cell-specific factors, including one or more of: an amount of congestion for a cell; an amount of interference for a cell; a number of user devices connected to a cell; an amount of available cell resources; or an amount of consumed or occupied cell resources. In an example implementation, the cell weights may be normalized, e.g., provided as values between 0 and 1, for example. A convention may be used, such that, for example, a higher cell weight may indicate a better (or more available) cell for transmitting traffic (signals or data), e.g., a higher cell weight may indicate or reflect a cell that has a lower cell load, less cell congestion, less cell interference, fewer user devices connected to the cell, etc. The opposite convention may alternatively be used for the cell weight where a lower cell weight may indicate a better (or more available) cell for transmitting data.

Each BS may determine a cell weight for one or more cells, and then send the cell weight to one or more user devices, or may broadcast the one or more cell weights. For example, a cell weight may be assigned by a BS for a cell based on a number of user devices connected to the cell, as an illustrative cell weight: For example, a cell weight of 0.9 may be assigned to a cell if 5 or less user devices are connected to the cell; a cell weight of 0.7 may be assigned to a cell if more than 5 and less than 20 user devices are connected to a cell; a cell weight of 0.5 may be assigned if at least 20 and fewer than 50 user devices are connected to the cell; a cell weight of 0.3 may be assigned to a cell that has at least 50 and less than 80 user devices connected to the cell; and a cell weight of 0.1 may be assigned to a cell that has more than 80 user devices connected to a cell, such that a higher or greater cell weight may indicate a better or more available cell, according to this illustrative example. These are merely some example numbers, provided for illustration, and other examples may be used. A similar approach may be used to assign a cell weight for each cell based on one or more other criteria, or based on a combination of criteria, such as cell congestion, amount of interference, etc. In general, the cell weight should reflect cell-wide conditions of the cell, and not limited to just one or a subset of connections or wireless links for the cell. A BS for the cell may determine the cell weight for one or more cells and may transmit or broadcast the cell weights to one or more user devices. For example, BS 134 may determine a cell weight for cell 136; BS 138 may determine a cell weight for cell 140, and BS 148 may determine a cell weight for cell 155. These cell weights may be updated and broadcast from time to time, e.g., every subframe, every frame, or other time period.

Also, according to an example implementation, the link-specific information for a wireless link may include a link-specific weight that may be determined by user device 132 based upon one or more link-specific factors for the wireless link. The link weight may, for example, describe or indicate the link's state (or status), such as, for example, indicate a link quality or indicate the link's availability (or unavailability) for wireless communications. According to an example implementation, the link-specific factors may include one or more of the following: a received signal strength indication (RSSI), a reference signal received power (RSRP) or a reference signal received quality (RSRQ) for the uplink wireless link or for a downlink wireless link corresponding to the uplink wireless link; a data error rate for the uplink wireless link or for a downlink wireless link corresponding to the uplink wireless link; a roundtrip transmission time for the uplink wireless link; a transmission power required to transmit from the user device to a base station via the uplink wireless link; and, a data throughput of the uplink wireless link or for a downlink wireless link corresponding to the uplink wireless link. Thus, a link-specific factor may be directly measured by the user device (e.g., path delay or round-trip time for the uplink wireless link), or may be indirectly measured based on a measurement performed by the user device for a corresponding downlink wireless link, e.g., a downlink wireless link that is provided on the same path as the uplink wireless link (e.g., by the user device measuring downlink RSSI, RSRP, and assuming that that uplink RSSI or uplink RSRQ is the same as the downlink RSSI and RSRQ, e.g., based on symmetry of uplink and downlink wireless links).

A variety of example techniques may be used to determine a link-specific weight based on one or more link-specific factors for the link. According to an illustrative example, several categories of RSRP may be determined or identified, and for example, a link weight of 0.9 may be assigned to an uplink wireless link where the RSRP (e.g., as measured by the user device for the corresponding downlink wireless link) is greater than a first threshold; a link weight of 0.7 may be assigned to an uplink wireless link with a corresponding downlink RSRP that is greater than a second threshold but less than the first threshold; etc. This is merely one illustrative example, and other techniques and examples may be used.

According to another illustrative example implementation, a weight function may be used or provided to determine link-specific weights, where the weight function associates relative weights (defined for corresponding values of link level measurements/link-specific factors) corresponding to different link quality metrics (or link-specific factors) which are taken into consideration and then the weight is summed up, in order to determine a link-specific weight.

### Example

Quality metrics (or link-specific factors) that may be taken into consideration for this illustrative example may include (for example): RTT (roundtrip transmission time), CQI (channel quality indication), Link throughput, Error Rate, RSSI, throughput (data throughput), etc. Example calculations are shown below for determining link-specific weights based on one or more link-specific factors or one or more quality metrics for each link:

For link 1,W1=w1(RTT)+w1(RSSI)+w1(Throughput)+w1(Error Rate)

For link 2,W2=w2(RTT)+w2(RSSI)+w2(Throughput)+w2(Error Rate)

Where W1(RTT),w1(RSSI),w1(Throughput) & w1(error Rate): correspond to weights for link level values for different quality metrics (or link-specific factors) and similarly for link2. The W1 (link-specific weight for link 1) and W2 (link-specific weight for link 2) represent the overall summed weights for link 1 and link 2 respectively, according to this illustrative example.

Based on the link-specific weights, links can be prioritized, e.g., W1<W2, so that link 1 is prioritized over link 2 for uplink transmission where a lower link-specific weight indicates better link quality, according to this illustrative example. Alternatively, a greater/higher link-specific weight may indicate a more available or higher quality uplink wireless link.

These are merely some illustrative examples, and a wide variety of techniques and approaches may be used to determine a link-specific weight based on one or more link-specific factors, for each of a plurality of uplink wireless links. Thus, one or more other link-specific factors may be used to determine a link-specific weight for each uplink wireless link.

According to an example implementation, the user device 132 may determine an overall link weight for each of the plurality of uplink wireless links based on the cell weight of a cell for (or that serves or provides) the uplink wireless link and the link-specific weight for the uplink wireless link. For example, with reference to FIG. 1, user device 132 receive the cell weights for each of cells 136, 140 and 155, e.g., received from master BS 134, secondary BS 138 and secondary BS 148, respectively, for example. User device 132 may measure or determine one or more link-specific factors for each of uplink wireless links 129, 139 and 149, e.g., based on signals received from the cell for the link. For example, user device 132 may measure RSSI, RSRQ, RSRP, data error rate, roundtrip transmission time, data throughput or other link-specific factor based on signals received from the cell or other measurement technique. User device 132 may determine a link-specific weight for each of links 129, 139 and 149 based on one or more link-specific factor(s) for each link, for example. The user device may then determine an overall link weight for uplink wireless link 129 based on a cell weight for cell 136 and a link-specific weight for uplink wireless link 129. Likewise, user device 132 may determine an overall link weight for uplink wireless link 139 based on a cell weight for cell 140 and a link-specific weight for uplink wireless link 139, and may determine an overall link weight for uplink wireless link 149 based on a cell weight for cell 155 and a link-specific weight for uplink wireless link 149. While only three uplink wireless links are used in this illustrative example, any number of uplink wireless links may be used or considered by the user device.

In an illustrative example implementation, the overall link weight for an uplink wireless link may be determined or calculated according to the following (by way of example):

Overall link weight=link-specific weight+cell weight(for the cell that serves the link).

Thus, in this illustrative example, the overall link weight for an uplink wireless link may be determined as a sum of the link-specific weight for the uplink wireless link plus the cell weight for the cell for (e.g., that serves) the uplink wireless link. This is merely one example technique that may be used to determine an overall link weight for an uplink wireless link, and other techniques may be used.

After the user device 132 has determined the overall link weight for each of the plurality of uplink wireless links, the user device 132 may select, based on the overall link weight for each of the plurality of uplink wireless links, one or more of the uplink wireless links for transmitting uplink traffic (data or signals) to the network. The selection of one or more uplink wireless links may be performed using a variety of different techniques. According to an illustrative example, the selecting of one or more uplink wireless links may be performed by: ranking, by the user device, the plurality of uplink wireless links based on the overall link weight for each uplink wireless link; and selecting, by the user device based on the overall link weight for each uplink wireless link, a set of (one or more) highest ranked uplink wireless links for transmitting data (either via a single link or via multi-connectivity). In this manner, the user device may select the best (or most available) one or more uplink wireless links, which may typically be the set of (one or more) highest ranked uplink wireless links, which maybe ranked according to the overall link weight for each uplink wireless link, according to an illustrative example implementation.

As an illustrative example, uplink wireless link 129 may have an overall link weight of 1.7, uplink wireless link 139 may have an overall link weight of 1.4, and uplink wireless link 149 may have an overall link weight of 1.2, where, in this example, a higher overall link weight may indicate a better or more available (more desirable, better performing) wireless link. Thus, for this example, the ranking of uplink wireless links may be the following, for example:

1) uplink wireless link 129—overall link weight of 1.7

2) uplink wireless link 139—overall link weight of 1.4

3) uplink wireless link 149—overall link weight of 1.2

Thus, in this example, the best (or most available) or highest ranked uplink wireless link is link 129 (e.g., based on its highest overall link weight), and is ranked as the highest ranked uplink wireless link. Next, link 139 is ranked as the next highest (or next best, or next most available) ranked uplink wireless link. Finally, link 149 is the third ranked uplink wireless link. Other links may similarly be ranked on this list. Thus, according to an example implementation, if the user device 132 selects only one uplink wireless link to transmit uplink traffic, then the user device may typically select link 129. If user device 132 selects two uplink wireless links to transmit uplink traffic, then the user device 132 may typically select links 129 and 139 (as the top two ranked uplink wireless links). And, if user device 132 select three uplink wireless links, then links 129, 139 and 149 would be selected, according to this illustrative example. Where two or more uplink wireless links are selected, this may be referred to as uplink multi-connectivity.

After ranking the uplink wireless links based on overall link weight and then selecting a set of one or more uplink wireless links for transmission, the user device 132 may make a decision to transmit data from the user device via the one or more selected uplink wireless link, and then the user device 132 may transmit data via the selected set of one or more uplink wireless links (e.g., based on uplink multi-connectivity if two or more uplink wireless links are selected and used for uplink transmission).

Furthermore, according to an example implementation, user device 132 (such as PDCP entity 216B, FIG. 2) may split uplink traffic (signals and/or data) among the plurality of selected uplink wireless links based on the relative values of the overall link weights for the plurality selected links. In some cases, the user device 132 (such as PDCP entity 216B, FIG. 2) may split the uplink traffic based on an overall link weight ratio for the selected uplink wireless links. Thus, the relative values of overall link weights, or a link weight ratio, may be used to allocate or split a portion (or percentage) of uplink traffic to each of the selected uplink wireless links. A ratio of an overall link weight to each of the other overall link weights for the set of selected uplink wireless links. For example, if overall link weight 1 for link 129 is twice as large as the overall link weight 2 for link 139, then twice as much traffic may be sent or transmitted over link 129 as compared to the amount of traffic sent over link 139, according to an illustrative example.

As another illustrative example, a sum of overall link weights may be calculated for a set of selected uplink wireless links, and then a ratio of: overall link weight/sum, may be determined for each of the selected links. Then an amount or proportion of split traffic that is allocated to each link may be based on the determined ratio for each link. In this manner, better or higher ranked uplink wireless links may be allocated a greater portion of the split traffic, and lesser or lower ranked uplink wireless links may be allocated a lesser (smaller) portion of the split traffic. In this manner, a greater amount of the split traffic is allocated and sent over the wireless link(s) that are best able to handle such load. In some cases, a proportional amount of the split traffic may be allocated to each link based on the link weight ratios. For example, a set of overall link weights may include the following, for example:

1) uplink wireless link 129—overall link weight of 2.0

2) uplink wireless link 139—overall link weight of 1.0

3) uplink wireless link 149—overall link weight of 1.0

In this illustrative example, the sum of overall link weights would be: 2.0+1.0+1.0=4.0. And the ratio for link 129 would be 2.0/4.0=0.5; the ratio for link 139 would be 1.0/4.0=0.25; and the ratio for link 149 would be 1.0/4.0=0.25. Thus, in the case of split traffic, an amount of data/traffic for data transmission may be allocated (e.g., by PDCP 216B) between each of these selected uplink wireless links in a ratio that is based on (or even proportional to, or even the same as, in some cases) a ratio of the overall link weights for each of the selected uplink wireless links. One example way to accomplish this is to allocate uplink traffic an amount, or in ratios, that matches or is proportional to the calculated ratios above for each of the links 129, 139, 149. Thus, one example way to accomplish this, would be to send/allocate 1/2 of the traffic via link 129 (based on the ratio of 0.5 for link 129), allocate ¼ of the traffic via link 139 (based on the ratio of 0.25 for link 139), and allocate ¼ of the traffic via link 140 (based on the ratio of 0.25 for link 149). This is merely one illustrative example, and other techniques may be used to allocate or split traffic based on ratios of the overall link weights of the selected uplink wireless links.

In addition, according to an example implementation, an amount of data in a data buffer of the user device 132 that is awaiting uplink transmission may be used to determine whether a single uplink wireless link or multiple uplink wireless links via multi-connectivity will be selected and used by the user device 132 for transmitting uplink data. For example, the user device 132 may receive a threshold (e.g., data threshold) from a BS (e.g., BS 134). The user device 132 may determine whether an amount of data, in a data buffer of the user device 132 awaiting uplink transmission is less than or equal to the threshold, or is greater than the threshold.

If, for example, the amount of data in the data buffer is less then or equal to the threshold, then the user device 132 may, for example, select only one uplink wireless link for transmitting data. This is because, for example, with less data being available for transmission, multiple uplink wireless links for uplink transmission may be unnecessary. Rather, if the data in the data buffer is less than or equal to the threshold, then the single (e.g., highest ranked) uplink wireless link may typically provide sufficient bandwidth or data throughput for transmission of such data.

On the other hand, if the amount of data in the data buffer of the user device is greater than the threshold, then the user device 132 may select a set of two or more (or a plurality of) uplink wireless links to transmit data via multi-connectivity. For example, in this case, the user device may select a set of a plurality of (e.g., two or three links) highest ranked wireless links based on the overall link weights for the plurality of uplink wireless links. For example, a primary wireless link may be selected (via a master BS 134) as the highest ranked wireless link, and one or more secondary wireless links (each via a secondary BS 138. 148) may be selected for multi-connectivity.

As another illustrative example, initially a user device 132 may be using a primary uplink wireless link 129 via a master BS 134 and one or more secondary uplink wireless links 139, 149 via secondary BSs 138, 148, via multi-connectivity. And, if the amount of data in the data buffer of the user device falls below the threshold, then the connections (between the user device and secondary BSs 138, 148) for the secondary wireless link(s) 139, 149 (via one or more secondary BSs) may be dropped or terminated, and uplink transmission of data may occur only via the primary uplink wireless link 129 (e.g., via the master BS 134). Similarly, if only one uplink wireless link 129 is initially used to transmit uplink traffic from the user device 132, and later, the amount of data in the data buffer of the user device 132 increases and now is greater than the threshold, then the user device 132 may establish connections with one or two additional BSs (e.g., BSs 138, 148) to allow data to also be transmitted via the secondary uplink wireless links 139 and 149 (in addition to transmitting via the primary wireless link 129/master BS 134), based on multi-connectivity.

According to an example implementation, different data thresholds may be used to indicate that different numbers of uplink wireless links can or should be used for uplink transmission from the user device 132. For example, if an amount of data in the data buffer of the user device is less than or equal to a first threshold, then only one uplink wireless link may or should be used by the user device to transmit uplink data. If an amount of data in the data buffer of the user device is greater than the first threshold and less than or equal to a second threshold, then the user device may or should use two uplink wireless links to transmit uplink data. And, if an amount of data in the data buffer of the user device is greater than the second threshold and less than or equal to a third threshold, then the user device may or should use three uplink wireless links to transmit uplink data. Thus, the number of uplink wireless links used by user device 132 for uplink data transmission may scale (or may be adjusted) according to (or based upon) the amount of data in the data buffer of the user device awaiting uplink transmission.

From time to time, or even periodically, the user device 132 may determine updated overall link weights for a plurality of uplink wireless links. For example, user device 132 may receive updated cell weights for cells for (or serving) each of the plurality of uplink wireless links. The user device 132 may also receive updated link-specific factors for each of the plurality of uplink wireless links. The user device 132 may then determine updated link-specific weights for each of the plurality of uplink wireless links. Based on the updated cell weights and updated link-specific weights for each of the plurality of uplink wireless links, the user device 132 may determine updated rankings of the plurality of uplink wireless links. The updated ranking of uplink wireless links may, in an illustrative example, be used to select one or more uplink wireless links for a next uplink wireless transmission from user device 132. Also, user device 132 may compare (again) the data in its data buffer (awaiting uplink transmission) to the threshold to determine whether one uplink wireless link, or multiple uplink wireless links, should be used for a next uplink wireless transmission.

In addition, the network or one or more BSs may send an updated threshold(s) to the user device 132. For example, the threshold may be adjusted/updated by the core network 150 and/or one or more BSs and then sent to user device 132 based on, e.g., network conditions, such as cell conditions (for example, based on cell weights for one or more cells) and/or link conditions (for example, overall link weights for one or more wireless links). For example, a higher/greater threshold may be set for a user device (for example, if one or more nearby cells have become more congested), e.g., in order to decrease the use of multi-connectivity by the user device 132. Likewise, the threshold may be decreased, e.g., to increase the usage by user device 132 of multiple uplink wireless links/uplink multi-connectivity.

Therefore, based on the updated cell weights and updated link-specific weights for each of the plurality of uplink wireless links, the user device 132 may determine updated overall link weights for each of the plurality of uplink wireless links, and then may perform an updated ranking of such links based on the overall link weights, for example. The user device may then determine whether the amount of data in a data buffer is greater than the threshold or not. If the amount of data is not greater than the threshold, then only one (e.g., the highest ranked) uplink wireless link may be used to transmit the uplink data, according to an illustrative example. However, if the amount of data in the data buffer is greater than the threshold, then two or more (e.g., highest ranked) uplink wireless links are selected to be used to transmit uplink data from the user device via uplink multi-connectivity. In the event that multiple uplink wireless links have been selected for use, the user device 132 may establish wireless connections to each BS to add or establish a new uplink wireless link for multi-connectivity for the user device.

Therefore, according to an example implementation, the various example implementations may provide a flexible and adjustable use of wireless resources, e.g., where the specific uplink wireless link(s) selected by the user device for uplink transmission may be changed or adjusted by the user device as the cell conditions (e.g., reflected by updated cell weights) and/or link conditions (e.g., reflected by updated link-specific factors and updated link-specific weights) change. Also, the number of uplink wireless links may be adjusted or varied, for example, based on a threshold and an amount of data in a data buffer of the user device awaiting uplink transmission. Thus, ranking and/or selecting one or more uplink wireless links for uplink transmission based on overall link weights for each of the links may allow the set of one or more highest ranked (or best) uplink wireless link(s) to vary or be adjusted based on the varying cell conditions and link conditions. Thus, a better set of one or more uplink wireless links may be selected by the user device based on use of both the cell weights that provide cell conditions at the cell level, and link-specific weights that provide local link conditions for each link. For example, a cell may be congested, even though one or more links for that cell may have high (or very good) RSSI/RSRQ, for example. Thus, relying on only one of cell conditions or link conditions may provide incomplete information for selecting wireless links. However, using both (or a combination of) cell weights and link-specific weights may provide better or more reliable information for the user device to select a better or best set of one or more uplink wireless links.

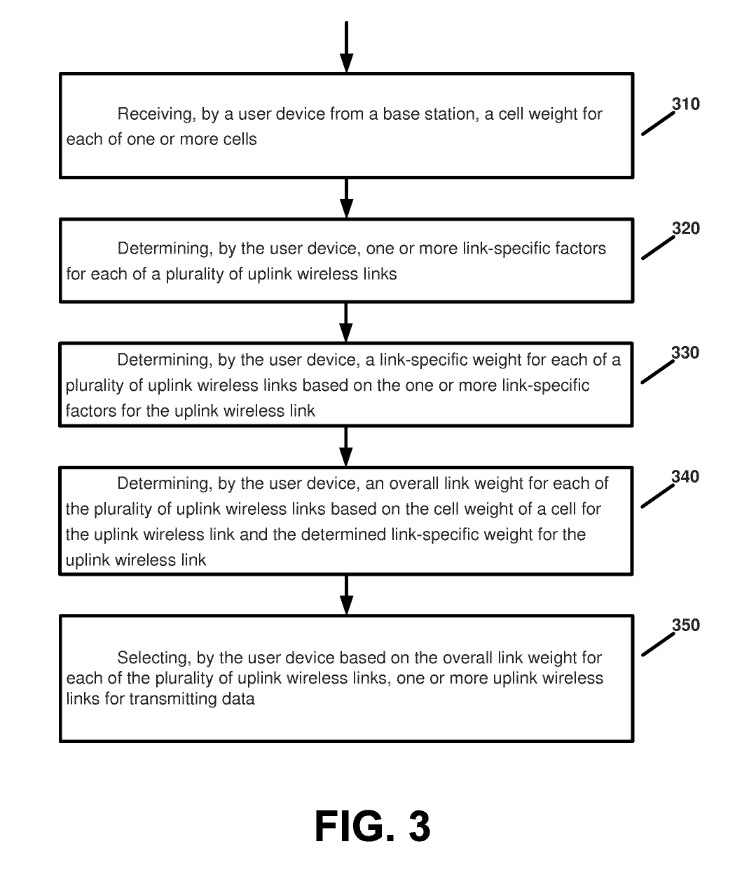

FIG. 3 is a flow chart illustrating operation of a user device according to an example implementation. The flow chart in FIG. 3 may illustrate a method of configuring a user device for communication in a wireless network. Operation 310 includes receiving, by a user device from a base station, a cell weight for each of one or more cells. Operation 320 includes determining, by the user device, one or more link-specific factors for each of a plurality of uplink wireless links. Operation 330 includes determining, by the user device, a link-specific weight for each of a plurality of uplink wireless links based on the one or more link-specific factors for the uplink wireless link. Operation 340 includes determining, by the user device, an overall link weight for each of the plurality of uplink wireless links based on the cell weight of a cell for the uplink wireless link and the determined link-specific weight for the uplink wireless link. And, operation 350 includes selecting, by the user device based on the overall link weight for each of the plurality of uplink wireless links, one or more uplink wireless links for transmitting data.

According to an example implementation of the method of FIG. 3, the selecting may include selecting, by the user device based on the overall link weight for each of the plurality of uplink wireless links, a single uplink wireless link for transmitting data.

According to an example implementation of the method of FIG. 3, the selecting may include selecting, by the user device based on the overall link weight for each of the plurality of uplink wireless links, a plurality of uplink wireless link for transmitting data via multi-connectivity.

According to an example implementation of the method of FIG. 3, the selecting may include ranking, by the user device, the plurality of uplink wireless links based on the overall link weight for each uplink wireless link; and selecting, by the user device based on the overall link weight for each uplink wireless link, a set of one or more highest ranked uplink wireless links for transmitting data via multi-connectivity.

According to an example implementation of the method of FIG. 3, the method may further include transmitting data, by the user device, via the selected one or more uplink wireless links.

According to an example implementation of the method of FIG. 3, the selecting may include receiving, by the user device from the base station, a threshold; determining, by the user device that the amount of data in the uplink buffer of the user device is less than the threshold; and selecting, by the user device based on the overall link weight for each uplink wireless link and based on the amount of data being less than the threshold, a single uplink wireless link for transmitting data.

According to an example implementation of the method of FIG. 3, the selecting may include receiving, by the user device from the base station, a threshold; determining, by the user device, that an amount of data in the uplink buffer of the user device is greater than the threshold; and selecting, by the user device based on the overall link weight for each uplink wireless link and based on the amount of data being greater than the threshold, a plurality of uplink wireless links for transmitting data based on uplink multi-connectivity.

According to an example implementation of the method of FIG. 3, the one or more link-specific factors associated with an uplink wireless link may include one or more of the following: a received signal strength indication (RSSI), a reference signal received power (RSRP) or a reference signal received quality (RSRQ) for the uplink wireless link or for a downlink wireless link corresponding to the uplink wireless link; a data error rate for the uplink wireless link or for a downlink wireless link corresponding to the uplink wireless link; a roundtrip transmission time for the uplink wireless link; a transmission power required to transmit from the user device to a base station via the uplink wireless link; and a data throughput of the uplink wireless link or for a downlink wireless link corresponding to the uplink wireless link.

According to an example implementation of the method of FIG. 3, the cell weight for each of one or more cells may include a cell weight that indicates or is based upon one or more of: a cell load for a cell; an amount of congestion for a cell; an amount of interference for a cell; and a number of user devices connected to a cell.

According to an example implementation of the method of FIG. 3, the method further including transmitting data, by the user device, via a plurality of selected uplink wireless links based on uplink multi-connectivity; wherein an amount of data for transmission is allocated between each of the uplink wireless links in a ratio that is based on a ratio of the overall link weights for each of the selected uplink wireless links.

According to an example implementation of the method of FIG. 3, the method further including transmitting data, by the user device, via a plurality of selected uplink wireless links based on uplink multi-connectivity; wherein uplink data is split among the plurality of selected uplink wireless links.

According to an example implementation of the method of FIG. 3, the method further including transmitting data, by the user device, via a plurality of selected uplink wireless links based on uplink multi-connectivity; wherein uplink data is duplicated on each of the plurality of selected uplink wireless links.

A computer program product, the computer program product comprising a computer-readable storage medium and storing executable code that, when executed by at least one data processing apparatus, is configured to cause the at least one data processing apparatus to perform a method of: receiving, by a user device from a base station, a cell weight for each of one or more cells; determining, by the user device, one or more link-specific factors for each of a plurality of uplink wireless links; determining, by the user device, a link-specific weight for each of a plurality of uplink wireless links based on the one or more link-specific factors for the uplink wireless link; determining, by the user device, an overall link weight for each of the plurality of uplink wireless links based on the cell weight of a cell for the uplink wireless link and the determined link-specific weight for the uplink wireless link; and selecting, by the user device based on the overall link weight for each of the plurality of uplink wireless links, one or more uplink wireless links for transmitting data.

An apparatus comprising at least one processor and at least one memory including computer instructions, when executed by the at least one processor, cause the apparatus to: receive, by a user device from a base station, a cell weight for each of one or more cells; determine, by the user device, one or more link-specific factors for each of a plurality of uplink wireless links; determine, by the user device, a link-specific weight for each of a plurality of uplink wireless links based on the one or more link-specific factors for the uplink wireless link; determine, by the user device, an overall link weight for each of the plurality of uplink wireless links based on the cell weight of a cell for the uplink wireless link and the determined link-specific weight for the uplink wireless link; and select, by the user device based on the overall link weight for each of the plurality of uplink wireless links, one or more uplink wireless links for transmitting data.

According to an example implementation of the apparatus, the causing the apparatus to select may include causing the apparatus to: select, by the user device based on the overall link weight for each of the plurality of uplink wireless links, a single uplink wireless link for transmitting data.

According to an example implementation of the apparatus, causing the apparatus to select may include causing the apparatus to: select, by the user device based on the overall link weight for each of the plurality of uplink wireless links, a plurality of uplink wireless link for transmitting data via multi-connectivity.

According to an example implementation of the apparatus, further causing the apparatus to transmit data, by the user device, via the selected one or more uplink wireless links.

According to an example implementation of the apparatus, wherein causing the apparatus to select includes causing the apparatus to: receive, by the user device from the base station, a threshold; determine, by the user device that the amount of data in the uplink buffer of the user device is less than the threshold; and select, by the user device based on the overall link weight for each uplink wireless link and based on the amount of data being less than the threshold, a single uplink wireless link for transmitting data.

According to an example implementation of the apparatus, the causing the apparatus to select may include causing the apparatus to: receive, by the user device from the base station, a threshold; determine, by the user device, that an amount of data in the uplink buffer of the user device is greater than the threshold; and select, by the user device based on the overall link weight for each uplink wireless link and based on the amount of data being greater than the threshold, a plurality of uplink wireless links for transmitting data based on uplink multi-connectivity.

According to an example implementation of the apparatus, the one or more link-specific factors associated with an uplink wireless link includes one or more of the following: a received signal strength indication (RSSI), a reference signal received power (RSRP) or a reference signal received quality (RSRQ) for the uplink wireless link or for a downlink wireless link corresponding to the uplink wireless link; a data error rate for the uplink wireless link or for a downlink wireless link corresponding to the uplink wireless link; a roundtrip transmission time for the uplink wireless link; a transmission power required to transmit from the user device to a base station via the uplink wireless link; and a data throughput of the uplink wireless link or for a downlink wireless link corresponding to the uplink wireless link.

According to an example implementation of the apparatus, the cell weight for each of one or more cells may include a cell weight that indicates or is based upon one or more of: a cell load for a cell; an amount of congestion for a cell; an amount of interference for a cell; and a number of user devices connected to a cell.

According to an example implementation of the apparatus, further causing the apparatus to: transmit data, by the user device, via a plurality of selected uplink wireless links based on uplink multi-connectivity; wherein an amount of data for transmission is allocated between each of the uplink wireless links in a ratio that is based on a ratio of the overall link weights for each of the selected uplink wireless links.

According to an example implementation of the apparatus, and further causing the apparatus to: transmit data, by the user device, via a plurality of selected uplink wireless links based on uplink multi-connectivity; wherein uplink data is split among the plurality of selected uplink wireless links.

According to an example implementation of the apparatus, and further causing the apparatus to: transmit data, by the user device, via a plurality of selected uplink wireless links based on uplink multi-connectivity; wherein uplink data is duplicated on each of the plurality of selected uplink wireless links.

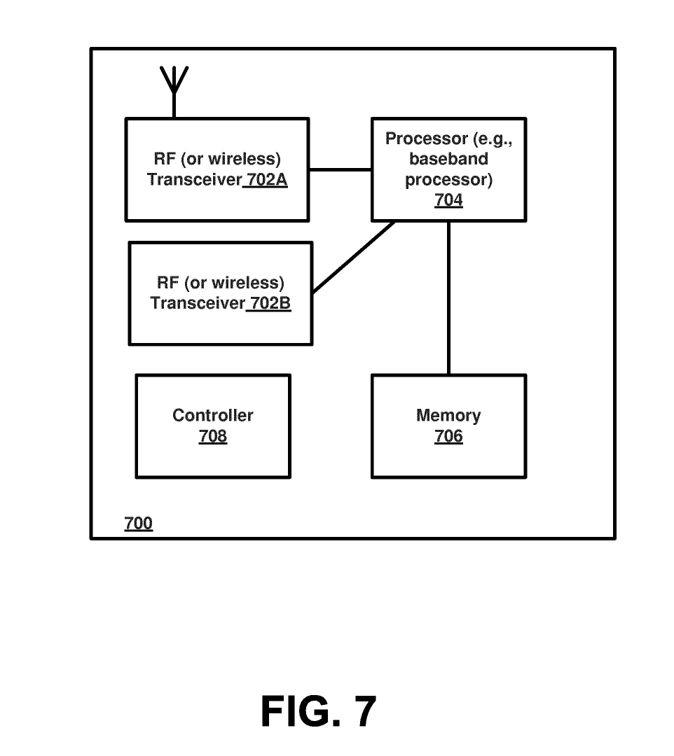

According to another example implementation, an apparatus may include means (e.g., 702A/702B and/or 704, FIG. 7) for receiving, by a user device from a base station, a cell weight for each of one or more cells, means (e.g., 702A/702B and/or 704, FIG. 7) for determining, by the user device, one or more link-specific factors for each of a plurality of uplink wireless links, means (e.g., 702A/702B and/or 704, FIG. 7) for determining, by the user device, a link-specific weight for each of a plurality of uplink wireless links based on the one or more link-specific factors for the uplink wireless link, means (e.g., 702A/702B and/or 704, FIG. 7) for determining, by the user device, an overall link weight for each of the plurality of uplink wireless links based on the cell weight of a cell for the uplink wireless link and the determined link-specific weight for the uplink wireless link, and means (e.g., 702A/702B and/or 704, FIG. 7) for selecting, by the user device based on the overall link weight for each of the plurality of uplink wireless links, one or more uplink wireless links for transmitting data.

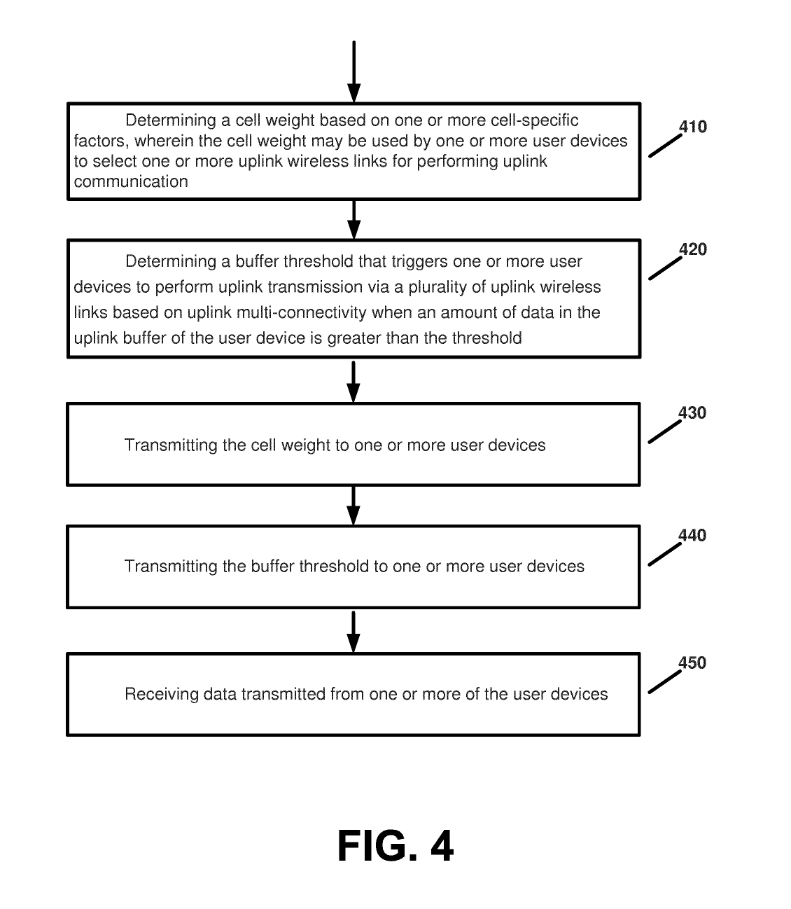

FIG. 4 is a diagram illustrating operation of a network device or base station according to an example implementation. Operation 410 includes determining a cell weight based on one or more cell-specific factors, wherein the cell weight may be used by one or more user devices to select one or more uplink wireless links for performing uplink communication. Operation 420 includes determining a buffer threshold that triggers one or more user devices to perform uplink transmission via a plurality of uplink wireless links based on uplink multi-connectivity when an amount of data in the uplink buffer of the user device is greater than the threshold. Operation 430 includes transmitting the cell weight to one or more user devices. Operation 440 includes transmitting the buffer threshold to one or more user devices. And, operation 450 includes receiving data transmitted from one or more of the user devices.

According to an example implementation of the method of FIG. 4, the cell-specific factors may include one or more of the following: a cell load for a cell; a number of user devices connected to a cell; an amount of interference for a cell; an amount of used or occupied resources for a cell, including one or more of computational resources, memory resources, network resources and wireless resources; and an amount of available resources for a cell, including one or more of computational resources, memory resources, network resources and wireless resources.

According to an example implementation of the method of FIG. 4, the transmitting the cell weight may include performing at least one of: broadcasting the cell weight to one or more user devices; transmitting the cell weight to one or more user devices as dedicated control information.

According to an example implementation of the method of FIG. 4, the method may further include transmitting control information to one or more user devices indicating an uplink wireless link to be used for uplink communications if an amount of data in the uplink buffer of the user device is less than the threshold.

According to another example implementation, an apparatus may include at least one processor and at least one memory including computer instructions, when executed by the at least one processor, cause the apparatus to determine a cell weight based on one or more cell-specific factors, wherein the cell weight may be used by one or more user devices to select one or more uplink wireless links for performing uplink communication, determine a buffer threshold that triggers one or more user devices to perform uplink transmission via a plurality of uplink wireless links based on uplink multi-connectivity when an amount of data in the uplink buffer of the user device is greater than the threshold, transmit the cell weight to one or more user devices, transmit the buffer threshold to one or more user devices, and receive data transmitted from one or more of the user devices.

According to another example implementation, a computer program product may include a computer-readable storage medium and storing executable code that, when executed by at least one data processing apparatus, is configured to cause the at least one data processing apparatus to perform a method including determining a cell weight based on one or more cell-specific factors, wherein the cell weight may be used by one or more user devices to select one or more uplink wireless links for performing uplink communication, determining a buffer threshold that triggers one or more user devices to perform uplink transmission via a plurality of uplink wireless links based on uplink multi-connectivity when an amount of data in the uplink buffer of the user device is greater than the threshold, transmitting the cell weight to one or more user devices, transmitting the buffer threshold to one or more user devices, and receiving data transmitted from one or more of the user devices.

According to another example implementation, an apparatus may include means (e.g., 702A/702B and/or 704, FIG. 7) for determining a cell weight based on one or more cell-specific factors, wherein the cell weight may be used by one or more user devices to select one or more uplink wireless links for performing uplink communication, means (e.g., 702A/702B and/or 704, FIG. 7) for determining a buffer threshold that triggers one or more user devices to perform uplink transmission via a plurality of uplink wireless links based on uplink multi-connectivity when an amount of data in the uplink buffer of the user device is greater than the threshold, means (e.g., 702A/702B and/or 704, FIG. 7) for transmitting the cell weight to one or more user devices, means (e.g., 702A/702B and/or 704, FIG. 7) for transmitting the buffer threshold to one or more user devices, and means (e.g., 702A/702B and/or 704, FIG. 7) for receiving data transmitted from one or more of the user devices.

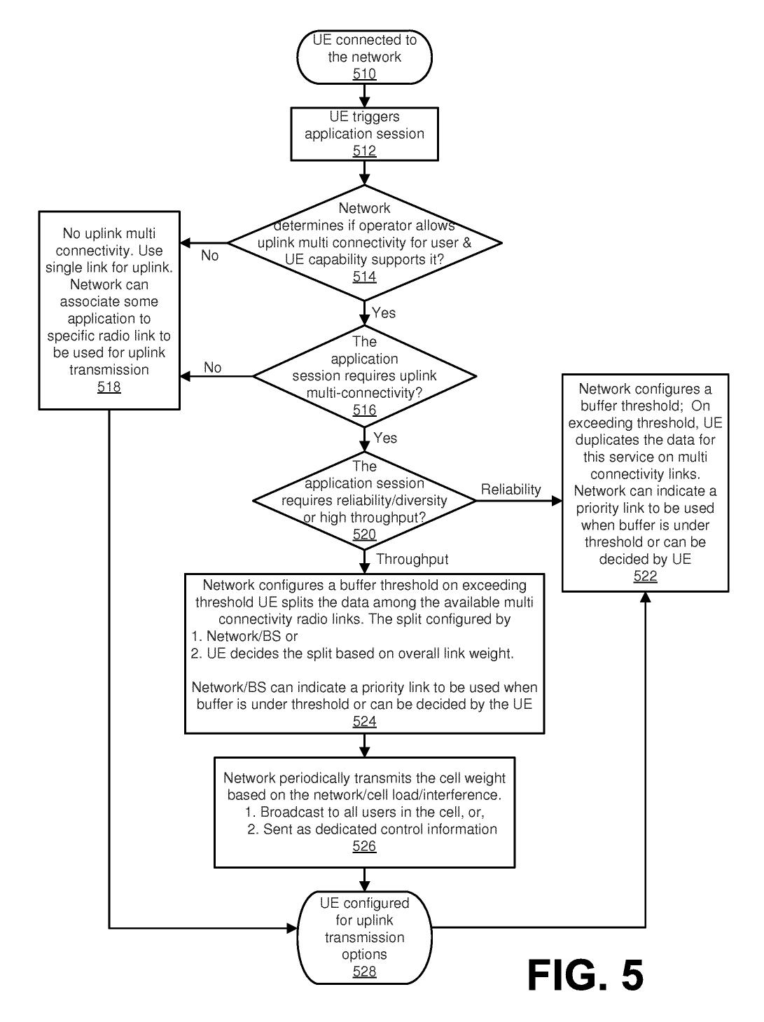

FIG. 5 is a flow chart illustrating operation of a network device or base station according to another example implementation. At 510, a UE (user device) is connected to the network (or connected to a BS). At 512, the UE triggers an application session. At 514, the network (e.g., core network and/or BS) evaluates whether network operator allows uplink multi-connectivity, and whether the UE capability supports uplink multi-connectivity. If uplink multi-connectivity is allowed and supported by UE, the process flow proceeds to 516, where network (e.g., BS) determines whether the application session requires uplink multi-connectivity. If the answer to either questions at 514 or 516 is not, then process flow proceeds to 518 where operation of UE and network proceeds without uplink multi-connectivity (e.g., using only a single link for uplink communications).

If the application session requires uplink multi-connectivity, the process flow proceeds to 520 where the network (e.g., BS) determines whether the application session requires data duplication (e.g., to improve reliability) or splitting to increase data throughput. Different application types may require different handling of uplink data for multi-connectivity, e.g., either split or duplicated data, based on quality of service requirements of an application, for example. For example, data may be split (by user device 132, such as by PDCP 216B, FIG. 2) for transmission of music, streaming video, Voice Over IP (VoIP) applications, etc., while latency-sensitive or time-critical applications (e.g., self driving vehicles) may require duplication of data to reduce latency and/or improve reliability. If improved reliability (data duplication) is required, then process flow proceeds to 522.

While if improved throughput (data splitting) is required by the application, then process flow proceeds to 524. At 522 (data duplication/reliability), the network (BS) configures a buffer threshold for the UE (e.g., sends the buffer threshold to the UE). When the amount of data in the user device data buffer exceeds such threshold, the UE (e.g., PDCP 216B) duplicates data for this service on the plurality of uplink wireless links for the uplink multi-connectivity. By data duplication, then means that every packet sent by the user device/UE would be sent over both (or all) of the selected uplink wireless links, hence packets are duplicated on all selected uplink wireless links. In addition, the network or BS may signal to the user device 132 a priority uplink wireless link that the user device 132 should use when data in the buffer is under (or less than) the threshold (when only using one link). Alternatively, the UE/user device may determine which uplink wireless link will be used as the priority link, e.g., as the highest uplink wireless link for the UE.

At 524 (data splitting to improve throughput), the network/BS may configure a buffer threshold for the user device/UE, e.g., by sending the buffer threshold to the user device/UE. If data in the buffer exceeds the threshold, the user device 132/UE (or PDCP 216B) splits the data among the plurality of uplink wireless links for multi-connectivity. By splitting, this may mean, for example, that packets for uplink transmission may be split or divided among the plurality of selected uplink wireless links, e.g., each packet may be sent over one of the uplink wireless links, and, for example, some packets may typically be sent over each of the selected uplink wireless links. The data split may be performed according to a split ratio, which may be determined by the network (e.g., BS, and then signalled to the user device), or may be determined by the user device 132/UE. If determined by the user device/UE, the split ratio may be determined based on, for example, overall link weights for the selected plurality of uplink wireless links (and/or ratio(s) of such overall link weights). For example, the split ratio may include allocating ½ of the traffic for the application session to link 129, ¼ of the uplink traffic for the application session to link 139, and ¼ of the uplink traffic for the application session to link 149. Also, the network or BS can indicate to the user device/UE a priority link to be used when data in the buffer is less than the threshold, or the user device/UE may determine a priority link to use (e.g., the highest ranked uplink wireless link).

At 526, the network/BS periodically transmits to one or more user devices/UEs the cell weight, which may be determined by the network/cell based on one or more cell factors such as network/cell load or interference, etc. At 528, various options of the UE/user device are configured for uplink communication (e.g., number of links, which uplink wireless links, data buffer threshold, . . . ), and then the user device/UE transmits uplink data per the one or more uplink wireless links.

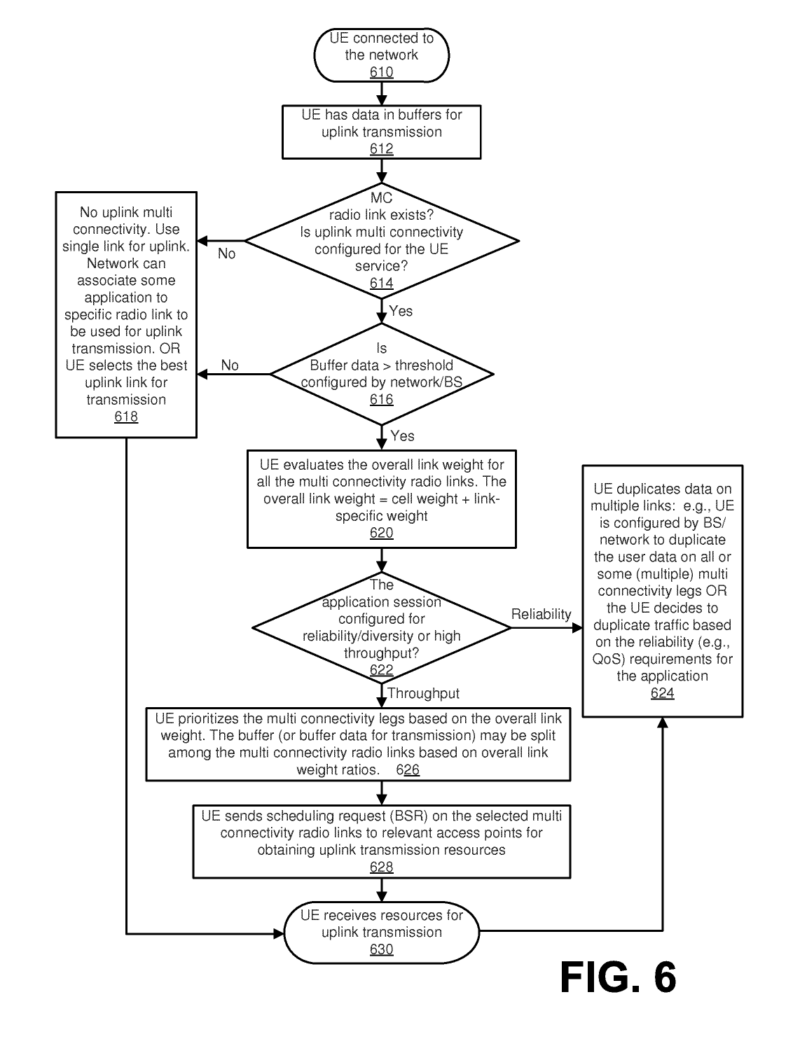

FIG. 6 is a flow chart illustrating operation of a user device according to another example implementation. At 610, the UE establishes a connection to a BS/network (e.g., BS 134). At 612, the UE determines that it has data in its buffer for uplink transmission. At 614, the UE determines if uplink multi-connectivity links are available, and if uplink multi-connectivity is configured for the UE service. If so, then process flow proceeds to 616 where the UE determines if the amount of data in the buffer is greater than the threshold (e.g., threshold received from the BS/network).

If the answer to questions at either 614 or 616 is no, then process flow proceeds to 618. At 618, there is no uplink multi-connectivity provided, and the UE and BS operate without such uplink multi-connectivity, e.g., using only one uplink wireless link. Network or the BS may indicate an uplink wireless link to use, or the UE may select an uplink wireless link to use, e.g., the highest ranked wireless link, or selecting a link using another technique.

If the amount of data in the buffer is greater than the threshold at 616, then process flow proceeds to 620. At 620, the UE evaluates the overall link weight for all or a plurality of uplink wireless links. The UE, for example, may rank the uplink wireless links (e.g., based on overall link weight for each link), and may select a set of a plurality of (e.g., a set of the best or highest ranked) uplink wireless links for multi-connectivity.

At 622, the UE (and/or the BS/network) determines if the application session is configured for improved throughput/data splitting or improved reliability/data duplication. If the application session is configured for reliability/data duplication, then at 624, the network/BS sends a message to configure the UE (e.g., to configure PDCP 216B, FIG. 2) to duplicate data for the application session on a set of multi-connectivity legs/links. Or, the UE may determine that it should duplicate data for the application session, e.g., based on the QoS (quality of service) requirements for the application, for example.

If the application session requires improved throughput/data splitting, at 626 the UE prioritizes (or ranks) the multi-connectivity legs (wireless links) based on the overall link weight for each of the uplink wireless links. The UE data buffer may also be split, e.g., according to the same ratio as the data splitting, so as to allocate a portion of data in the buffer to each (or for transmission via each) of the plurality of uplink wireless links. Thus, for example, data in portion 1 of the UE buffer may be transmitted via link 1, and data in portion 2 of the UE buffer may be transmitted via link 2, etc. At 628, for each of the uplink wireless links, the UE sends a scheduling request (such as a buffer status report (BSR) indicating an amount of data in a buffer awaiting uplink transmission) to obtain uplink resources from a BS to allow the UE to transmit the data in the buffer for the link. At 630, the UE receives the uplink resources, and then transmits the data in the buffer (s) via each of the uplink wireless links using the obtained uplink resources.

FIG. 7 is a block diagram of a wireless station (e.g., BS/AP or user device) 700 according to an example implementation. The wireless station 700 may include, for example, one or two RF (radio frequency) or wireless transceivers 702A, 702B, where each wireless transceiver includes a transmitter to transmit signals and a receiver to receive signals. The wireless station also includes a processor or control unit/entity (controller) 704 to execute instructions or software and control transmission and receptions of signals, and a memory 706 to store data and/or instructions.

Processor 704 may also make decisions or determinations, generate frames, packets or messages for transmission, decode received frames or messages for further processing, and other tasks or functions described herein. Processor 704, which may be a baseband processor, for example, may generate messages, packets, frames or other signals for transmission via wireless transceiver 702 (702A or 702B). Processor 704 may control transmission of signals or messages over a wireless network, and may control the reception of signals or messages, etc., via a wireless network (e.g., after being down-converted by wireless transceiver 702, for example). Processor 704 may be programmable and capable of executing software or other instructions stored in memory or on other computer media to perform the various tasks and functions described above, such as one or more of the tasks or methods described above. Processor 704 may be (or may include), for example, hardware, programmable logic, a programmable processor that executes software or firmware, and/or any combination of these. Using other terminology, processor 704 and transceiver 702 together may be considered as a wireless transmitter/receiver system, for example.

In addition, referring to FIG. 7, a controller (or processor) 708 may execute software and instructions, and may provide overall control for the station 700, and may provide control for other systems not shown in FIG. 7, such as controlling input/output devices (e.g., display, keypad), and/or may execute software for one or more applications that may be provided on wireless station 700, such as, for example, an email program, audio/video applications, a word processor, a Voice over IP application, or other application or software.

In addition, a storage medium may be provided that includes stored instructions, which when executed by a controller or processor may result in the processor 704, or other controller or processor, performing one or more of the functions or tasks described above.

According to another example implementation, RF or wireless transceiver(s) 702A/702B may receive signals or data and/or transmit or send signals or data. Processor 704 (and possibly transceivers 702A/702B) may control the RF or wireless transceiver 702A or 702B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1. A method of configuring a user device for uplink communication in a wireless network, the method comprising:
receiving, by a user device from a base station, a cell weight for each of one or more cells;
determining, by the user device, one or more link-specific factors for each of a plurality of uplink wireless links;
determining, by the user device, a link-specific weight for each of a plurality of uplink wireless links based on the one or more link-specific factors for the uplink wireless link;
determining, by the user device, an overall link weight for each of the plurality of uplink wireless links based on the cell weight of a cell for the uplink wireless link and the determined link-specific weight for the uplink wireless link; and
selecting, by the user device based on the overall link weight for each of the plurality of uplink wireless links, one or more uplink wireless links for transmitting data.

2. The method of claim 1 wherein the selecting comprises:
selecting, by the user device based on the overall link weight for each of the plurality of uplink wireless links, a single uplink wireless link for transmitting data.

3. The method of claim 1 wherein the selecting comprises:
selecting, by the user device based on the overall link weight for each of the plurality of uplink wireless links, a plurality of uplink wireless link for transmitting data via multi-connectivity.

4. The method of claim 1 wherein the selecting comprises:
ranking, by the user device, the plurality of uplink wireless links based on the overall link weight for each uplink wireless link; and
selecting, by the user device based on the overall link weight for each uplink wireless link, a set of one or more highest ranked uplink wireless links for transmitting data via multi-connectivity.

5. The method of claim 1 and further comprising:
transmitting data, by the user device, via the selected one or more uplink wireless links.

6. The method of claim 1 wherein the selecting comprising:
receiving, by the user device from the base station, a threshold;
determining, by the user device that the amount of data in the uplink buffer of the user device is less than the threshold; and
selecting, by the user device based on the overall link weight for each uplink wireless link and based on the amount of data being less than the threshold, a single uplink wireless link for transmitting data.

7. The method of claim 1 wherein the selecting comprises:
receiving, by the user device from the base station, a threshold;
determining, by the user device, that an amount of data in the uplink buffer of the user device is greater than the threshold; and
selecting, by the user device based on the overall link weight for each uplink wireless link and based on the amount of data being greater than the threshold, a plurality of uplink wireless links for transmitting data based on uplink multi-connectivity.

8. The method of claim 1 wherein the one or more link-specific factors associated with an uplink wireless link comprises one or more of the following:
a received signal strength indication (RSSI), a reference signal received power (RSRP) or a reference signal received quality (RSRQ) for the uplink wireless link or for a downlink wireless link corresponding to the uplink wireless link;
a data error rate for the uplink wireless link or for a downlink wireless link corresponding to the uplink wireless link;
a roundtrip transmission time for the uplink wireless link;
a transmission power required to transmit from the user device to a base station via the uplink wireless link; and
a data throughput of the uplink wireless link or for a downlink wireless link corresponding to the uplink wireless link.

9. The method of claim 1 wherein the cell weight for each of one or more cells comprises a cell weight that indicates or is based upon one or more of:
a cell load for a cell;
an amount of congestion for a cell;
an amount of interference for a cell; and
a number of user devices connected to a cell.

10. The method of claim 1, and further comprising:
transmitting data, by the user device, via a plurality of selected uplink wireless links based on uplink multi-connectivity;
wherein an amount of data for transmission is allocated between each of the uplink wireless links in a ratio that is based on a ratio of the overall link weights for each of the selected uplink wireless links.

11. The method of claim 1, and further comprising:
transmitting data, by the user device, via a plurality of selected uplink wireless links based on uplink multi-connectivity; wherein uplink data is split among the plurality of selected uplink wireless links.

12. The method of any of claim 1, and further comprising:
transmitting data, by the user device, via a plurality of selected uplink wireless links based on uplink multi-connectivity; wherein uplink data is duplicated on each of the plurality of selected uplink wireless links.

13-14. (canceled)

15. A computer program product, the computer program product comprising a computer-readable storage medium and storing executable code that, when executed by at least one data processing apparatus, is configured to cause the at least one data processing apparatus to perform the method of claim 1.

16. An apparatus comprising at least one processor and at least one memory including computer instructions, when executed by the at least one processor, cause the apparatus to:
receive, by a user device from a base station, a cell weight for each of one or more cells;
determine, by the user device, one or more link-specific factors for each of a plurality of uplink wireless links;
determine, by the user device, a link-specific weight for each of a plurality of uplink wireless links based on the one or more link-specific factors for the uplink wireless link;
determine, by the user device, an overall link weight for each of the plurality of uplink wireless links based on the cell weight of a cell for the uplink wireless link and the determined link-specific weight for the uplink wireless link; and
select, by the user device based on the overall link weight for each of the plurality of uplink wireless links, one or more uplink wireless links for transmitting data.

17-26. (canceled)

27. A method comprising:
determining a cell weight based on one or more cell-specific factors, wherein the cell weight may be used by one or more user devices to select one or more uplink wireless links for performing uplink communication;
determining a buffer threshold that triggers one or more user devices to perform uplink transmission via a plurality of uplink wireless links based on uplink multi-connectivity when an amount of data in the uplink buffer of the user device is greater than the threshold;
transmitting the cell weight to one or more user devices;
transmitting the buffer threshold to one or more user devices; and
receiving data transmitted from one or more of the user devices.

28. The method of claim 27 wherein the cell-specific factors comprise one or more of the following:
a cell load for a cell;
a number of user devices connected to a cell;
an amount of interference for a cell;
an amount of used or occupied resources for a cell, including one or more of computational resources, memory resources, network resources and wireless resources; and
an amount of available resources for a cell, including one or more of computational resources, memory resources, network resources and wireless resources.

29. The method of claim 27 wherein the transmitting the cell weight comprises performing at least one of:
broadcasting the cell weight to one or more user devices;
transmitting the cell weight to one or more user devices as dedicated control information.

30. The method of claim 27 and further comprising:
transmitting control information to one or more user devices indicating an uplink wireless link to be used for uplink communications if an amount of data in the uplink buffer of the user device is less than the threshold.

31-32. (canceled)

33. A computer program product, the computer program product comprising a computer-readable storage medium and storing executable code that, when executed by at least one data processing apparatus, is configured to cause the at least one data processing apparatus to perform the method of claim 27.
